(19) United States
(12) Patent Application Publication
(10) Pub. No.: US 2004/0024730 A1
(43) Pub. Date: Feb. 5, 2004

(54) Inventory management of products

(76) Inventors: Thomas M. Brown, Vestal, NY (US); Richard T. Evans, Endicott, NY (US); Mary B. Wilcoxen, Apalachin, NY (US)

Correspondence Address: McGuire Woods LLP, Suite 1800, 1750 Tysons Boulevard, Tysons Corner, McLean, VA, 22102-4215, US

(21) Appl. No.: 10/210,079

(22) Filed: Aug. 2, 2002

(51) Int. Cl. G06F 7/00

(52) U.S. Cl. 707/1

(57) ABSTRACT

Inventory management of work-in-process (WIP) inventory within a processing facility is accomplished with a staged holding area in concert with control systems. Receiving of material into the staging area is tracked by scanning mechanisms such as Radio Frequency ID (RFID) or bar coding methods. Aggregation of material is recorded by cart sizing factors into the automatic control system. Carts are stored temporarily in locations arranged in a pre-determined grid fashion. The grid location information for a cart is made known to the automatic control system for reference or reporting to production supervisors. Down-stream processing can request staged inventory material from staging operators via overhead message boards or computer screens. Requests may be by particular types of material or by specific cart grid location. Manual entry or manual release of material is also accommodated including manual corrections of staged materials. Release of entire cart contents to down-stream processing is converted to actual material counts

### BACKGROUND OF THE INVENTION

1. Field of the Invention

The present invention generally relates to inventory control systems and in particular to an inventory control system for a material handling system having both automatic and manual controls.

2. Background Description

Inventory management is an ever-increasing critical component of total supply chain operations. The efficiency and dependability of material handling within overall inventory control systems often impacts the timeliness of product delivery and overall ability to maintain optimum capacity of an operation as a whole.

To an extent, manufacturing and processing supervisors must know how much work-in-process (WIP) inventory exists in order to plan operations and allocate resources. WIP is routinely staged in carts of varying sizes or containers in processing facilities such as, for example, postal facilities. Currently, a rough volume count is manually acquired as supervisors walk through the facility taking visual assessment of inventory. If the staging area holding WIP inventory is out-of-view or distant from the supervisors, determining the WIP volume count is thus greatly hampered. This leads to inefficiencies throughout the delivery and production processes.

Production processes can be driven by one of two methods. First, a customer order input system may be decomposed into raw material needs and production capacity requirements in order to fill customer orders. Alternatively, production processes may be driven by the amount and type of material that is placed in the system at the input end by spontaneous demand. In either scenario, problems exist which need to be addressed.

An example of the first type of production process is a manufacturer of consumer goods that build products to fill orders for finished goods. In this example, the inventory management is driven by the end target quantities as defined by customer orders and promise date. Typically, production assets can be scheduled with reasonable certainty of availability. Raw materials can also be verified before hand. Once the production cycle begins, however, intermediate production steps may cause disruptions that require flexible tracking methods.

An example of the second type of production process is the Postal Service. The type and quantity of materials that have been placed into this type of system drive the production flow, i.e., the amount and type of mail that the public has mailed drives the overall process and, for the most part, its service commitments. Historical trends tend to guide decisions regarding anticipated workflow and WIP. But, in this second type of process, changes and timing of volume can affect overall efficiencies. Ability to adjust the physical location tracking and manually adjusting material flow quantity counts thus becomes important.

Production costs are also tied to raw material, parts and sub-assembly availability when they are in demand, and may equally lead to inefficiencies in the overall operation. For example, unavailable parts and material often cause undesirable delays in meeting throughput capacities goals. Often these delays can be attributed to inefficient part and material tracking methods and systems within an operation. When parts and materials cannot be timely ascertained or confidence in available quantity is low, this has a similar effect as not being available. It is thus apparent that efficiencies in operations require that down-stream production activities and machinery be properly scheduled and presented with the output from upstream processes in a timely manner.

Reliable tracking of the output from upstream processes and every intermediate stage is also a part of the overall goal of efficient production. However, in many situations, material and parts are held in a staging area for relatively short periods of time, typically a shift, or if necessary over a day. It is in these staging areas or temporary holding areas that work-in-process (WIP) inventory can be subject to reduced tracking controls. Aggregation of material into larger containers for temporary storage can also lead to tracking and delivery problems if the aggregation count is not carefully quantified on entry and release of materials.

Often, in these staging areas, multiple modes of entering parts and materials can exist and multiple modes of releasing materials from the staging areas can also exist. Coordinating the different modes of entering and releasing materials can be a source of inventory inaccuracies, particularly when these modes include both automatic and manual methods simultaneously. For example, once material enters a staging area, supervisors or others must manually inspect the WIP inventory to ascertain approximate inventory. However, the same inventory control and tracking must also be performed when the material is exiting the staging area. This is a time consuming process which tends to lead to inaccuracies and inefficiencies in the tracking process. Thus, introduction of tracking methods at the staging point entry and exit would increase efficiencies and improve accuracy.

### SUMMARY OF THE INVENTION

In accordance with a first aspect of the present invention, a system is provided for managing staged material in a processing facility. The system includes a staging area controller for tracking and, in embodiments, reporting material entering and exiting a staging area of the processing facility and for managing storing of the staged material in a storage area such as a bulk-grid storage area. The staging area controller is able to access an inventory database that contains data structures to record material entering and exiting the staging area and to record location assignment of the material when placed in the storage area. This system maintains a substantially accurate inventory of stage material.

In embodiments, the system includes a sorter discharge sensor for scanning and sorting the material entering the staging area and a scanning device for scanning the material that exits the staging area. Additionally, the system may comprise a material system controller that manages the overall processing facility inventory. A network connects the material system controller, the staging area controller, the sorter discharge sensor and a scanning device. A message board may be provided for displaying material requests and demands.

The method of use of the system involves receiving material and sorting the material form by material ID. The material entering and exiting the storage area is recorded in a database via the material ID. The location of the material is also recorded. This information is then used to track and managing the material entering and exiting the staging area by accessing the recorded information in the database.

In embodiments, the material is loaded into a container, and an accounting is provided by by incrementing a container counter. The method of the present invention may further include checking if the container is full by comparing the counter to a limit, displaying a grid location in the storage area which is displayed by accessing the database which contains data reflecting storage availability. The container is then moved to the grid location in the storage area and a container inventory is incremented. The method further includes the steps of displaying operational demands on a message board display or displays which request material. As a result, the material is entered into automation equipment that is scanned to record the exiting of the material from the staging area, and inventory counts are updated. A reconcile function can be performed by operators when no containers of a type are in the staging area. The reconcile function resets the container inventory in the database.

In another aspect of the present invention, the method includes the steps of displaying an operational demand on a message board display and entering the material onto an automation equipment conveyor. Thereafter, scanning the material entered onto the automation equipment conveyor is provided. The current container counter is then decremented to reflect the count of the material in a container. A check is determined to see whether the current container counter has reached a limit. The container inventory is then decremented to reflect a count of the containers.

For automatically entering material, the material is placed in a container, which may be a rolling or other type of container, and is directed by the controller to a specific grid location of a bulk-storage location that is arranged in a grid-like fashion. In this manner, the controller associates a material type with location. The controller also knows the quantity of material since it tracked and counted by type and container. The controller also knows the amount of material or parts that can be held by a container. It also is aware of the grid storage arrangement and available locations as containers enter and exit.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is an exemplary layout of a staging area of the present invention;

FIG. 2 is an exemplary block diagram of the staging area of FIG. 1 with bulk staging grid and material flow diagram of the present invention;

FIG. 3 is an exemplary block diagram of the inventory control computer system architecture of the present invention along with supporting devices;

FIG. 4 is a physical-to-logical and logical-to-physical conversion block diagram and flow during product containerization and staging of the present invention;

FIG. 5 is a flow diagram showing the steps of using the present invention to stage product material; and

FIG. 6 is a flow diagram showing the steps of using the present invention to release product material from a staging area.

### DETAILED DESCRIPTION OF A DETAILED EMBODIMENT OF THE INVENTION

The present invention provides flexible inventory tracking control at the staging area, both at the entry and exit points. By way of example, as material or sub-assemblies move along WIP stages, material may be moved along in singular counts, i.e., one unit is accounted for at a time, or material may be aggregated into totes or containers or may be broadly defined to include totes and containers. Aggregation is typically performed at a staging area to improve storage efficiencies, where the staging area is typically an intermediate holding area that provides a temporary storage area for sub-assemblies or material until down-stream process demand the staged inventory. When the material reaches a staging area for aggregation and storing in carts or containers, the flow of material often requires automation, and manual operator input, to optimize efficiencies and to harmonize the automatic and manual modes. The present invention combines automatic scanning of materials discharged off a conveyor system to be recorded and tracked with materials entering the staging area by manual efforts and manually scanned. The present invention may also combine automatic scanning of material exiting the staging area. By keeping track of the materials entering and exiting the staging area, overall efficiencies of the system are increased. The present invention may be utilized in any known processing facility ranging from, for example, a postal facility to an automobile assembly plant to a host of other illustrative facilities.

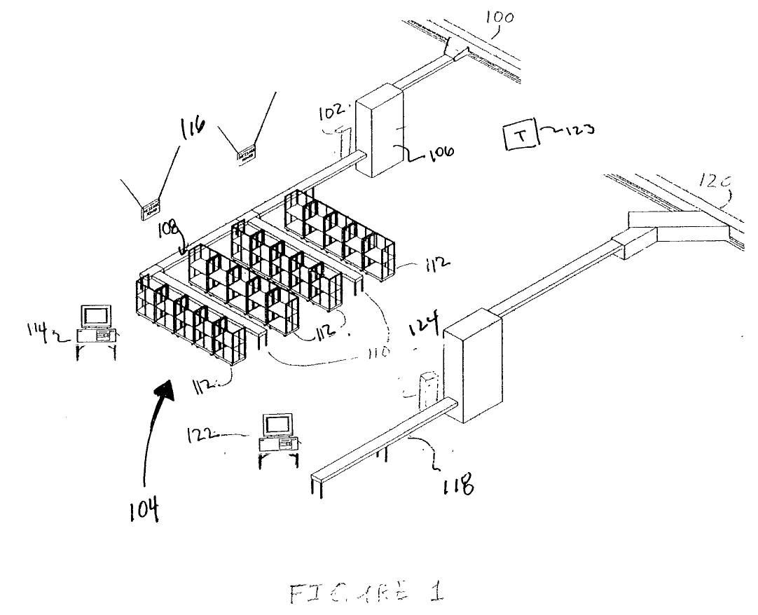

FIG. 1 depicts an exemplary staging area of the present invention. An automated conveyor system 100 moves material or parts within a processing or manufacturing facility. The use of material and parts may be defined broadly to include, for example, any fungible items or a multitude of items and the like and may further include the aggregation of such into containers, totes, holding, bins and the like. The parts or materials may be placed onto the automated conveyor system 100 by an inventory management computer system as a result of an order placement by a customer. In the exemplary case of the Postal Service, the parts may be mail totes as presented to the system in lieu of any order placement; however, the present application is not limited to single parts or a single type of material and several parts or materials may be easily tracked by the use of the present invention.

In the present invention, the parts or material are tracked on the conveyor 100 by an information gathering system 102 such as bar coding, radio frequency identification (RFID) technology. In embodiments, the materials or parts may be conveyed in totes or trays, where the totes may bear the bar coding or RFID reader technology. The tote may hold multiple parts of the same type (or, in embodiments, of different types) and are typically used to move bundled parts and material. The aggregation of materials into totes and totes into containers allows easier handling and accounting of material passing through a staging area. If a tote contains more than one part or material, it is a pre-determined quantity that is associated with the tote so that the inventory management system of the present invention is aware of the total counts. Variable numbers of parts or materials (hereinafter material and parts may be used interchangeably) per tote of the same type should be avoided unless the tracking method can differentiate the counts within a tote. The scanned information may be provided to an inventory database of the present invention.

Still referring to FIG. 1, the material handling system delivers material to a staging area generally shown as 104. An elevator 106 may be employed to facilitate transport of material from the overhead conveyors 100 to floor-level conveyors 108. The material is sorted based on the scanned information and directed to one of several breakouts 110. Operators then stack the incoming totes on rolling or other types of containers or carts 112. In embodiments, each container 112 typically contains the same type of material or part; however, it should be well understood that different materials or parts are also contemplated by the present invention.

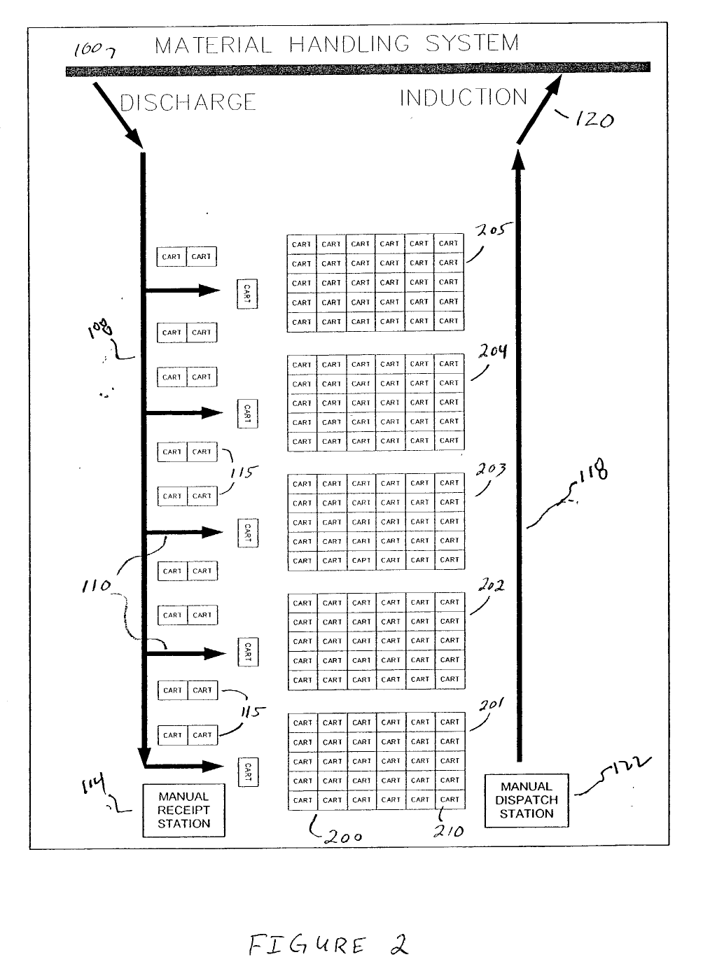

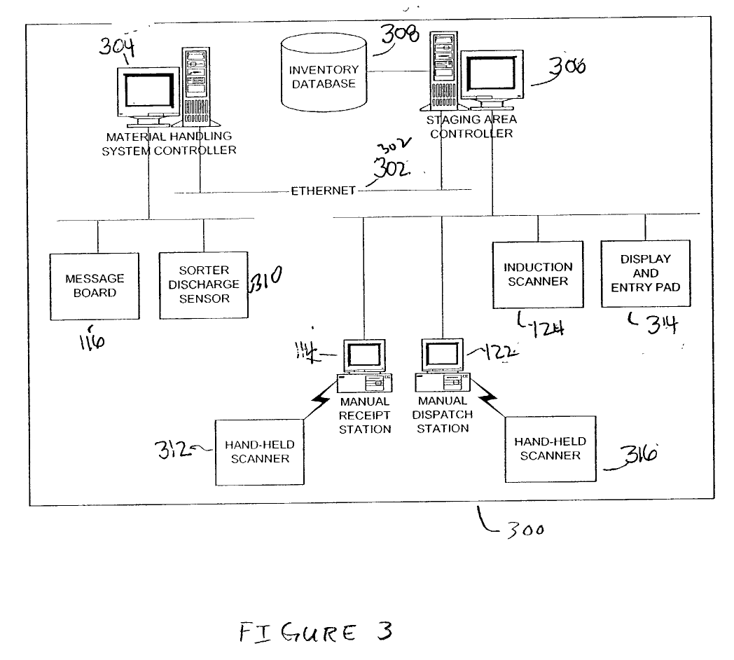

Once the containers are full, the containers 112 are then rolled to assigned locations in a bulk-staging grid 200 as depicted in FIG. 2. Down-stream processes may order carts of staged inventory as needed via the automation control system of the present invention. Material requests are conveyed via computer monitors, e.g., 114, or via overhead message boards 116. The message board 116 arrangement may drive the requests for material to exit the bulk-storage area either automatically or manually. Operators respond to the material requests by locating and re-inserting material onto the conveyor system on a floor-level conveyor 118 which is then elevated as necessary into an induction-side main conveyor system 120. A manual dispatch station 122 may be used to enter the cart number, as described in more detail with reference to FIG. 3, prior to the loading of the induction-side main conveyor system 120. A timer may be associated with the system of the present invention 123, as discussed in detail below. An induction scanner 124 may also be used to scan the parts.

Referring now to FIG. 2, a schematic representation of FIG. 1 is shown. In this representation, a bulk-staging grid 200 is provided. In the embodiments of the invention, the inventory system associates parts to containers by a pre-defined mapping such as, for example, thirty-six totes per container. The inventory system also associates containers with a particular grid location such as 210. The grid may be organized so that material of a particular type is grouped together in the bulk-staging grid as illustrated by blocks 201, 202, 203, 204, and 205. These blocks are illustratively shown in FIG. 2 as five by six grids, but any grid size is possible. Access spacing may be provided between containers so those containers in the middle of a grid may be moved without shuffling other containers.

Various methods of grid designation may be employed as long as unique identification is conveyed for any given grid location. For example, each grid may be designated by a unique ordinal number, or, alternatively, a block number and grid number within the block may be employed. Alternatively, blocks may be designated by color coding schemes. An inventory database (shown in FIG. 3) of the present invention reflects and records location assignment data of material and containers assigned to the bulk-storage grid and reflects storage availability.

FIG. 3 is an exemplary block diagram showing the architecture of the inventory management system 300 of the present invention. The inventory management system 300 comprises a network backbone 302 that may be an Ethernet or similar local area network topology that connects a material system controller 304 to various other components such as, for example, a staging area controller 306 and the message board 116. The material system controller 304 is the main inventory management application. The material system controller 304 software and the staging area controller 306 software may reside on the same platform; however, the location of these controllers can be any convenient place and may even be distant from the staging area. The controllers 304 and 306 can update the message board 116 with inventory information and inventory part requests as required to communicate with operators.

The staging area controller 306 controls the entry of material into the staging area and maintains inventory status on an inventory database 308 that is accessible to the staging area controller 306 (i.e., processes and displays operational demands). The staging area controller 306 further controls the accounting of material or parts into and out of a staging area. In use and by way of illustrative example, operations in the facility can demand product from the staging area by product type, which the stage area controller 306 can translate to a particular container or containers and the storage location. The staging area controller 306 is thus aware of the locations and parts (including multiple parts or material) per tote and is thus capable of calculating the totes per container as required. Also, crosschecks on expected staged material by type of material could be performed by the staging area controller 306 thereby increasing the efficiencies and providing up to date reporting capability to users of the system. A report may be requested by anyone on the network to facilitate production planning, and may include, amongst other items, material counts and container counts by type and location within the staging area storage.

Still referring to FIG. 3, the inventory database 308 permits tracking and recording of material entering and exiting the staging area and contains data structures reflecting material type and count and quantities of containers of material by type. If material is packaged in totes, the database 308 contains data structures to reflect the amount of totes per container. The database 308 also reflects the aggregation ratio of totes per container and material per container. The bulk-grid layout structure is also maintained in the database 308 in order to store container locations and to recognize available grid locations.

FIG. 3 further shows a sorter discharge sensor 310 connected to the Ethernet. In embodiments, the sorter discharge sensor 310 reads WIP material types as they are discharged from the material handling system. The sorter discharge sensor 310 can be bar code readers or RFID technology or other sensing techniques. The staging area controller 306 receives the material information from the sorter discharge sensor 310 and routes the part or material to an appropriate break-out 110 where the part or material is placed into a rolling container or cart 112. WIP parts or materials may actually be partially processed product, completed product, or totes containing any of these.

It should be well understood by those of ordinary skill in the art that it is possible to receive WIP inventory from another source such as from a loading dock, internal processing point, or alternate source. When material arrives for entering the staging area other than via the material handling system 100, the manual receiving station 140 can account for the material. Material received in this manner is typically already in rolling containers. A hand-held scanner 312 may also be used to record the new container. In this manner, the manual dispatch station 122, associated with the hand-held scanner 312, communicates the arrival of the container to the staging area controller 306 via network connections, which updates the inventory database 308.

Down-stream personnel or production systems can enter a request for WIP material into the material system controller 304. The material system controller 304 coordinates with the staging area controller 306 in determining material availability. If the staging area controller 306 finds a particular type of material in the inventory database 308, a message is sent to one or more message boards 116. The message will request a particular cart at a particular grid location to be rolled to the induction conveyor automation equipment 118. Even if the database 308 indicates no particular type of WIP inventory is available, a request may still be made to the message boards 116 for the particular type of part or material. This request instigates a visual check by operators as a safeguard against inaccurate database data. Corrections to the database can be made if parts are indeed located.

Once a cart arrives at the induction conveyor 118, an operator enters the cart number into a display entry pad 314 located near or above the induction conveyor which is connected via Ethernet to the staging area controller 306. The entry of the cart number causes the staging area controller 306 to retrieve part information and packaging information regarding the cart. The database 308 contains the amount of parts per cart and the amount of parts per tote, if necessary. As parts are removed from the cart and placed on the induction conveyor 118 by an operator, the parts are scanned by the induction scanner 124, which is also connected via Ethernet to the staging area controller 306. As parts are placed on the induction conveyor 118 and scanned, the inventory database 308 is updated by decrementing the WIP parts count.

It should also be understood that circumstances might require material or parts to be released from the staging area by manual dispatch. This occurs if material is not being placed on the induction conveyor 118 but transported to a destination by means other than automated equipment such as a conveyor. In this case, the manual dispatch station 122 is used to enter the cart number, or alternatively, a hand-held scanner 316 may be used. The inventory database 308 is decremented to reflect the reduction in inventory. If a request is made on the message boards 116 and there are no carts that satisfy the demand, an inventory reconcile function is preformed. The operator reconciles the inventory counts by causing the inventory count to be set to zero.

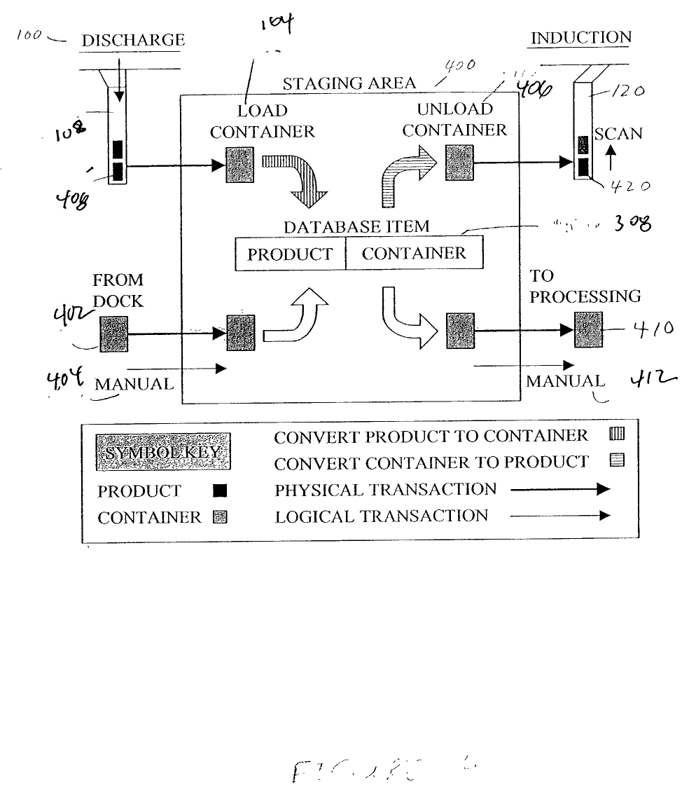

FIG. 4 illustrates flow of material through a staging area in both automatic and manual manner and shows the updating of the database on entry and exit thereof. Material 420 enters the staging area 104 by the conveyor system discharge 100 to the floor-level conveyor 108. The material is physically loaded in to a container as shown by 430. The database 308 is updated to reflect a new container for the given product material. As seen in FIG. 4, the product and container, depicted as a database item, is now represented in the database. Containerized material entering from another source such as a loading dock 402 is physically rolled to the staging area and the database 308 is manually updated to reflect the arrival of the container as shown by logical transaction 404. A hand-held scanner such as that shown in FIG. 3, may be used to record the arrival of the container or a manual receiving (or receipt) station 114 used to accept the container.

When material is subsequently requested from a staging bulk-storage area, the request asks for a particular container or cart by grid location or the request may ask for generic material by type. The requests on the message board 116 are sorted by priority and may be color-coded to reflect priorities. The container may be released from the storage by unloading the container, shown at process point 406, onto the induction floor-level conveyor 118. The material 408 is automatically scanned when placed on the induction conveyor 118 and the inventory database 308 is decremented to reflect the material counts placed on the conveyor.

As material is placed on the conveyor to exit the staging area, the staging area controller 306 monitors the material count and anticipates the material count associated with the container. The staging area controller 306 verifies the count for a container since the container count is kept and stored in the inventory database. If excess material is placed on the conveyor that exceeds the quantity stored in the database 308 for a given container, a message is sent to the operator to query if unloading of a new container has begun. The operator performs correction or adjustment of container counts as necessary using the display and entry pad mounted above or near the induction conveyor. This double check increases accuracy of inventory counts. As material is placed onto the conveyor and scanned, the timer is reset in order to monitor the timing of material entry. If the timer ever lapses, the operator is queried whether the container has been emptied. This permits proper accounting of containers with less than full materials. The timer duration is programmable for a given facility and typically is a few minutes.

Containerized material may be physically removed from the staging area and delivered to other processing areas 410 by other means. Manual updates to the inventory database 308 are performed manually as shown by logical transaction 412. A hand-held scanner may perform this function in conjunction with the display and entry pad.

As is thus now understood, when an operational demand for material is displayed, operators locate the proper container and either manual move it to a destination and scan the container 112 on exiting the area or the container 112 is emptied onto an automatic induction conveyor. When the container 112 is emptied onto the induction conveyor, the staging area controller 308 of the present invention monitors the material that is placed on the induction conveyor 120 by the scanning device. When the automation inventory control system 300 calls out for more material, the system informs operators on the message board displays 116 or computer monitor such as 114 as to which cart at a specific grid location (described in further detail below) to roll to the induction entry point 118. The operator typically enters the entire contents of a cart at one time. The information gathering system 102 registers the entry of material by scanning the totes. As carts are scanned and totes enter the conveyor, the system decrements inventory tallies for the on-hand inventory for the part or material type. The tally is adjusted based on the site-defined conversion of quantity per cart, validate the amount of material placed onto the induction conveyor and query operators whenever a mismatch occurs. Operators are capable of correcting erroneous data. If a demand request is displayed on a message board 116 and no material exists of that type in the staging area, a function to reconcile the counts is performed by the operators to reset the inventory database in the staging area controller for that material type.

### Method of Using the Present Invention

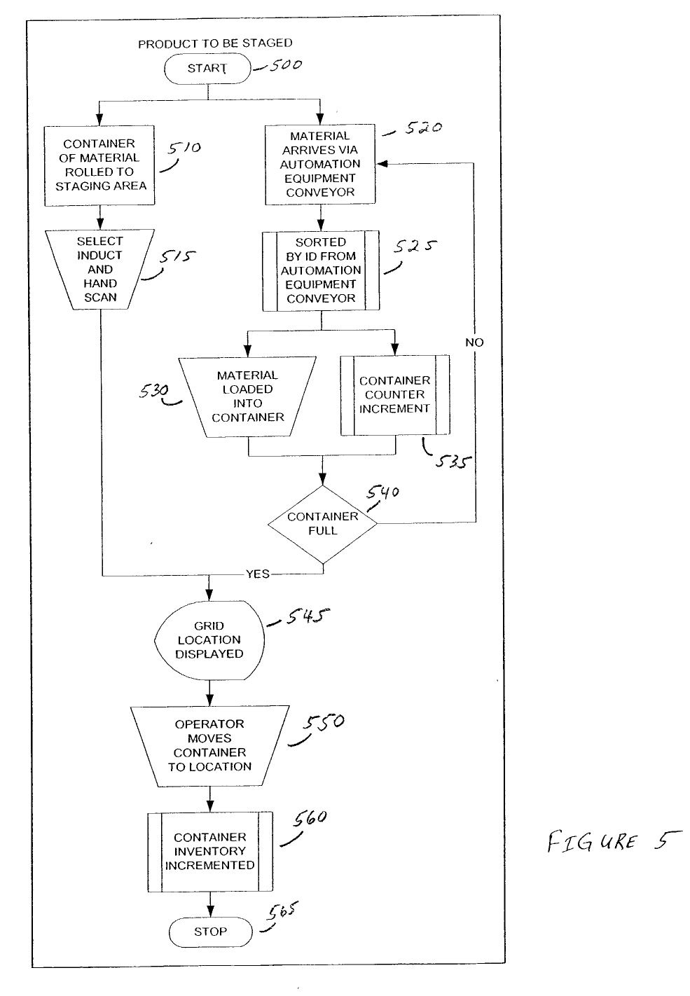

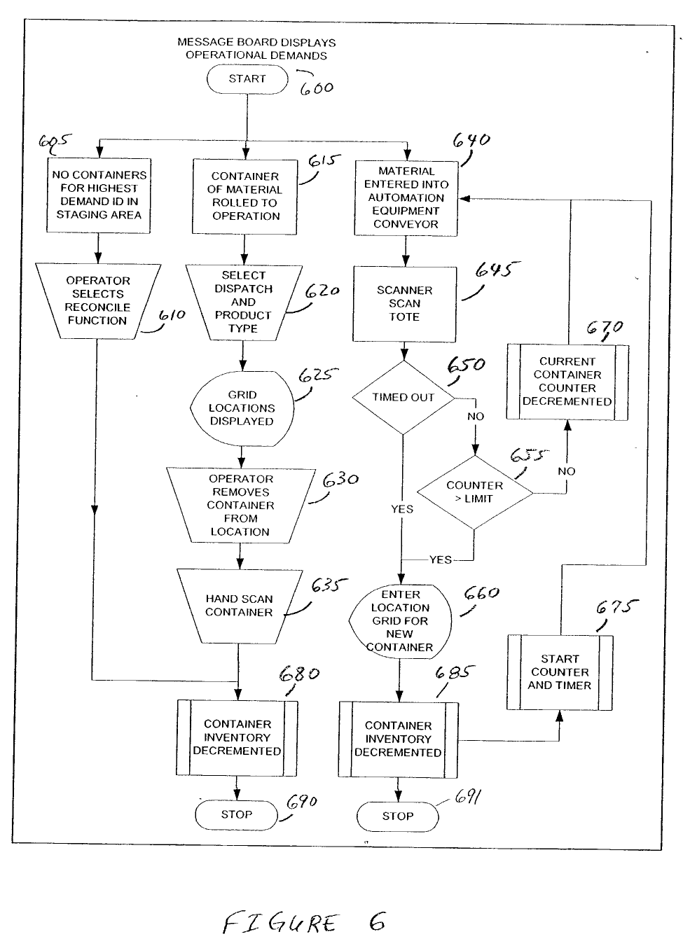

FIGS. 5 and 6 are flow diagrams showing the steps implementing the present invention. A computer software program or hardwired circuit can be used to implement the steps of the present invention. In the case of software, the program can be stored on media such as, for example, magnetic media (e.g., diskette, tape, or fixed disc) or optical media such as a CD-ROM. Additionally, the software can be supplied via the Internet or some other type of network. A workstation or personal computer that typically runs the software includes a plurality of input/output devices and a system unit that includes both hardware and software necessary to provide the tools to execute the steps of the present invention.

FIG. 5 is a flow diagram of steps involved in using the present invention. The method begins at step 500 with product available to be staged. If the arriving product material is already containerized (e.g., from a loading dock), the container, which may contain totes, is rolled to the staging area as shown by step 510. One item of the container is hand scanned or a manual receiving station employed to record the arrival of the containerized material as shown at step 515. The staging area controller extrapolates the quantity within the container when one item (which may be a tote) is scanned. This alleviates an operator from necessarily scanning each and every tote or item within the container, thus improving overall efficiencies. The grid location (e.g., location 210) for the storage of the container is displayed on the dispatch station 122 by the staging area controller 306. In step 550, an operator moves the container to the displayed grid location. The container inventory is incremented in the inventory database 308 as shown by step 560. This example process for staging is complete at step 565 and resumes when new product arrives for staging.

If, however, product material arrives via automation equipment (e.g., conveyor 100) as shown in step 520, then the material is sorted by scanned identification (ID) at step 525 and routed to an appropriate run-out 110. This scanning and routing is under control of the staging controller 306. As a tote or material is loaded into a container by an operator as shown in step 530 a database entry, container counter, is also incremented as shown by step 535. At step 540, a check is made as to whether the container is full. The staging controller has pre-defined information on the maximum quantity of material that can be held by a container. If it is not full, processing continues with step 520. If the container is full, a grid location is displayed for storing the container as shown by step 545. The operator moves the container to the grid location at step 550 and the database entry, container inventory, is incremented as shown at step 560. The process is complete at step 565 and resumes when more material product arrives.

The flow diagram in FIG. 6 depicts the method of the present invention for managing the staged inventory and releasing or dispatching the material from the staging area. A display on a message board for a particular type of product material initiates the process at step 600. This message is instigated by processes demanding staged material and typically originates from personnel using the material system controller 304 via terminals in a production facility. Multiple message boards may be employed. The material system controller 304 may refer requests to the staging area controller 306 for the staged material or users may directly make requests to the staging controller. If no containers with the demanded ID is available as shown by block 605, then a reconcile function is selected by an operator at step 610 to inform the staging area controller 306 that no material exists in the staging area. This causes the container inventory to be decremented or zeroed as performed at step 680 and the process stops a step 690. Typically, a visual check for staged material is made as a safeguard.

If a requested container must be rolled or transported to an operation manually as shown by block 615, then a manual entry is made by selecting a manual dispatch option on the manual dispatch station 122 using the product ID as shown at step 620. Grid locations of suitable containers are displayed on the terminal as shown at step 625. An operator selects and removes a container from a grid location as shown at step 630 then hand scans the container or manually enters the selection. The inventory database 308 is decremented to reflect the removal of the container from the staging area as shown at step 680. The process stops at 690 until another a message board displays a new request.

For material that has been requested by grid location or material type for entry into automation equipment as shown in block 640, the container is unloaded onto the conveyor 118 and the material or totes are scanned at step 645 by the scanner for induction into the material handling system 120. If the scan timer has not expired, it is reset and a check is made by the staging controller, which is monitoring the scanning, at step 655 to see if the container count has been exhausted and the limit for the container reached. If not, the container has more material, the container counter is decremented at step 670 and the process continues at step 640.

If the counter has reached the limit for the container, or the timer expired which indicates a pause in the material entry and probable partial size container, a query to the operator asks from what grid the next container is coming as shown in step 660. The container inventory is decremented at step 685 and if another container exists, a new counter for the new container is started with a new timer as shown at step 675. The process continues at step 640 with unloading of the next container. If no more containers are available, the process completes at step 691. Any inconsistencies in the counts are correctable by operators.

While the invention has been described in terms of preferred embodiments, those skilled in the art will recognize that the invention can be practiced with modifications and in the spirit and scope of the appended claims.

Having thus described our invention, what we claim as new and desire by Letters Patent is as follows:

1. A system for managing staged material in a processing facility, the system scanning material entering and exiting the system, comprising:
an inventory database containing data structures to record the material entering and exiting a staging area of the processing facility and to record location assignment data of the material; and
a staging area controller which accesses the inventory database for tracking and managing the material entering and exiting the staging area of the processing facility,
wherein a substantially accurate inventory of staged material is maintained by the system.

2. The system according to claim 1, wherein the staging area contains a storage area which is a bulk-grid storage area.

3. The system according to claim 1, further comprising:
a material system controller which manages overall processing facility inventory;
a sorter discharge sensor for scanning and sorting the material entering the staging area;
a scanning device for scanning the material exiting the staging area; and
a network connecting the material system controller, the staging area controller, the sorter discharge sensor and the scanning device to enable communication therebetween.

4. The system of claim 3, wherein:
the sorter discharge sensor comprises one of a bar code reader and a Radio Frequency Identification reader; and
the scanning device for scanning the material exiting the staging area comprises one of a bar code reader and a Radio Frequency Identification reader.

5. The system of claim 1, further comprising:
at least one message board for displaying material requests;
a display and entry pad for entering updates to the inventory database; and
a manual receipt station for receiving the material manually into the staging area.

6. The system of claim 5, further comprising a manual dispatch station for releasing the material manually from the staging area.

7. The system of claim 1, wherein the staging area controller further manages storing of the staged material in a storage area associated with the staged area.

8. The system of claim 1, further comprising at least one hand-held scanner for scanning the material into and from the staging area.

9. The system of claim 1, further comprising at least one conveyor for discharging and inducting the material to and from the staging area, respectively.

10. The system of claim 1, further comprising a timer for monitoring the timing of the induction of the material from the staging area.

11. The system of claim 1, wherein the inventory database contains data structures reflecting material type and at least one of count and quantities of the material and location area via a bulk-grid layout structure.

12. A method for managing material entering and exiting a staging area in a processing facility and for storing the material in a storage area, the method comprising the steps of:
sorting the material by material ID as it enters the staging area;
recording the material entering and exiting the staging area in a database via the material ID;
recording location assignment data of the material in the staging area in the database; and
tracking and managing the material entering and exiting the staging area by accessing the recorded information in the database.

13. The method of claim 12, further comprising:
loading the material into at least one container;
incrementing a container counter in the database to reflect a count of the material in the container;
displaying a grid location in a storage location associated with the staging area, the grid location being displayed by a staging area controller accessing the database which contains data reflecting storage availability;
moving the at least one container to the grid location in the storage location; and
incrementing the container inventory in the database based on the moving step.

14. The method of claim 13, further comprising checking whether the container is full by comparing the container count to a limit.

15. The method for managing staged material of claim 13, further comprising the steps of:
receiving the at least one container moved to the staging area;
scanning the at least one container to record the arrival of the material into the staging area in the database.

16. The method for managing staged material of claim 13, further comprising the steps of:
displaying operational demands on a message board display which requests the material;
entering the material into automation equipment;
scanning the material entered into the automation equipment which records the exiting of the material from the staging area;
decrementing a current container counter in the database to reflect the amount of the material in the the at least one container;
checking whether the current container counter has reached a limit;
decrementing container inventory in the database to reflect a current count of the the at least one container.

17. The method for managing staged material of claim 13, further comprising the steps of:
selecting the material to be moved to an operation based on a material request on a message board;
displaying grid locations of the selected material in the storage area;
removing the at least one container from a specified grid location in the storage area which holds the selected material; and
scanning the at least one container to record the exiting of the container from the staging area.

18. The method according to claim 13, further comprising the step of requesting a report that includes information on container counts, material counts, and containers by location.

19. A method for managing material entering and exiting a staging area in a processing facility wherein the staged material is stored in a bulk-grid storage location, the method comprising the steps of:
displaying an operational demand on a message board display;
entering the, material onto an automation equipment conveyor;
scanning the material entered onto the automation equipment conveyor;
decrementing a current container counter in a database to reflect the count of the material in a container;
checking whether the current container counter has reached a limit;
decrementing a container inventory in the database to reflect the count of containers if the limit has been reached.

20. The method for managing staged material of claim 19, further comprising the steps of:
selecting the material to be moved to an operation based on material request on the message board;
displaying grid locations of selected the material in the bulk-storage location;
removing the container from a grid location in the bulk-storage location;
scanning a container which records in the database the exiting of the material from the staging area.

21. The method for managing staged material of claim 18, further comprising the step of performing a reconcile function when no containers of a type are in the bulk-grid storage location, the reconcile function resetting the container inventory in the database.
